(19) United States
(12) Patent Application Publication
(10) Pub. No.: US 2011/0088026 A1
(43) Pub. Date: Apr. 14, 2011

(54) MOBILE DEVICE APPLICATION UPDATE MANAGEMENT

(76) Inventor: Brendon Swann, Islington Christchurch (NZ)

(21) Appl. No.: 12/576,447

(22) Filed: Oct. 9, 2009

(51) Int. Cl. G06F 9/445; G06F 9/44; G06F 3/048

(52) U.S. Cl. 717/173; 717/178; 717/174; 715/748

(57) ABSTRACT

A method of updating an application on a mobile device is disclosed. One embodiment obtains a device identifier from the mobile device. In addition, at least one updatable application associated with the device identifier that is available to install on the mobile device is obtained from an installation manager. The at least one updatable application is installed on the mobile device and the installation manager is updated to represent that the at least one updatable application is installed on the mobile device.

### FIELD

The invention relates to a technique and system for updating or installing an updatable application on a mobile device.

### BACKGROUND

A Navigation satellite system (NSS) is a space based radio positioning network for providing users equipped with suitable receivers highly accurate position, velocity, and time (PVT) information. One of the most recognizable NSS systems is the global positioning system (GPS) developed by the United States of America, although there are numerous other systems including local NSS's that utilize fewer satellites in a geosynchronous orbit. Thus, although the following background describes the operation of the GPS system in particular, it is appreciated that the description is meant to provide a generic overview of NSS operations as opposed to specific reliance on a single NSS.

In general, the space based portion of GPS comprises a constellation of GPS satellites in non-geosynchronous 12-hour orbits around the earth. GPS satellites are located in six orbital planes with four of the GPS satellites in each plane, plus a number of “on orbit” spare satellites for redundancy. The orbital planes of the GPS satellites have an inclination of 55 degrees relative to the equator and an altitude of approximately 20,200 km (10,900 miles) and typically complete an orbit in approximately 12 hours. The positions of GPS satellites are such that a minimum of five of the total constellation of GPS satellites are normally observable (above the horizon) by a user anywhere on earth at any given time.

One problem for mobile devices including GPS receivers is updating any applications thereon. For example, if an application is updated for currency, efficiency, better performance, bug fixes, or the like, the update may never make it onto a specific device. For example, the user may not have heard about the update, may not be technologically savvy enough to retrieve the update, or the like. Worse, in an environment that utilizes a number of the mobile devices, the job of updating each device may be quite time-consuming and cause significant loss of device use while they are being updated.

### SUMMARY OF THE INVENTION

Embodiments provided herein recite methods and systems of updating an application on a mobile device. One embodiment obtains a device identifier from the mobile device. In addition, at least one updatable application associated with the device identifier that is available to install on the mobile device is obtained from an installation manager. The at least one updatable application is installed on the mobile device and the installation manager is updated to represent that the at least one updatable application is installed on the mobile device.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a mobile device in accordance with one embodiment of the present technology.

FIG. 2 is a block diagram of a system for installing and updating updatable applications on a mobile device in accordance with one embodiment of the present technology.

FIG. 3 is a block diagram of an exemplary user interface for accessing the installation manager on a mobile device in accordance with one embodiment of the present technology.

FIG. 4 is a block diagram of a computer system in accordance with one embodiment of the present technology.

FIG. 5 is a block diagram of an example NSS receiver which may be used in accordance with one embodiment of the present technology.

### DESCRIPTION OF EMBODIMENTS

Reference will now be made in detail to embodiments of the invention. While the invention will be described in conjunction with the different embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the embodiments in accordance with the present invention, numerous specific details are set forth in order to provide a thorough understanding of the embodiments of the present invention. However, the embodiments in accordance with the present invention may be practiced without these specific details. In other instances, well-known methods, procedures, components, and circuits have not been described in detail so as not to unnecessarily obscure aspects of the embodiments in accordance with the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, step, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the embodiments in accordance with the present invention, discussions utilizing terms such as “receiving” or “processing” or “decrypting” or “encrypting” or “decoding” or “encoding” or “acquiring” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One embodiment described herein relates to GPS Receiver Patents Showing General Functionality as described in detail in U.S. Pat. No. 4,847,862 issued Jul. 11, 1989 and which is assigned to the assignee of the present application, and in U.S. Pat. No. 5,486,834 issued Jan. 23, 1996 which is assigned to the assignee of the present application, and in U.S. Pat. No. 5,621,416 issued Apr. 15, 1997 which is assigned to the assignee of the present application and which are incorporated by reference for all purposes.

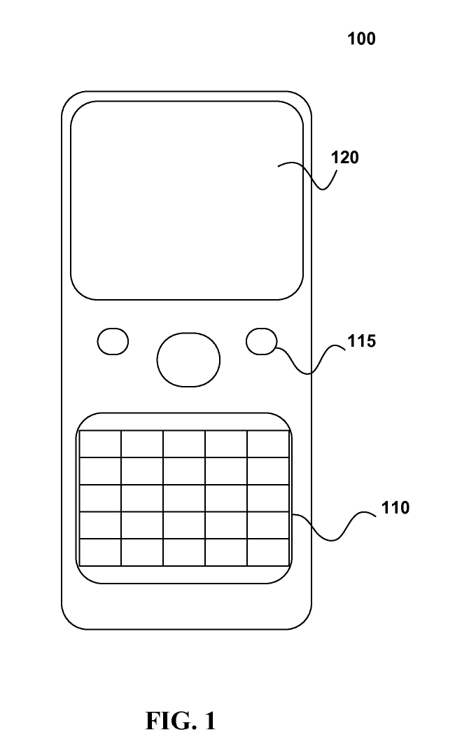

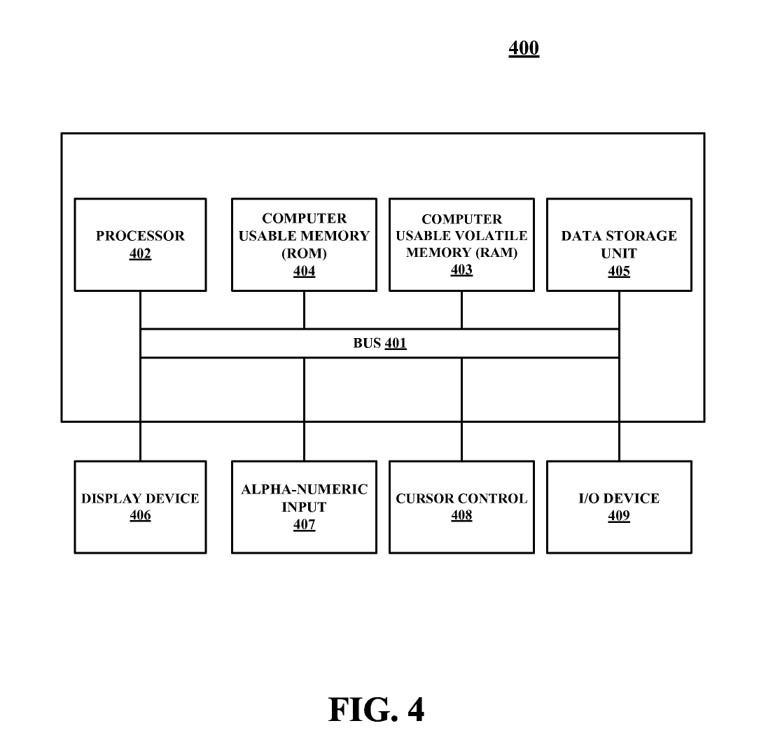

FIG. 1 is a block diagram of an exemplary mobile device 100 used in accordance with one embodiment. In general, handheld computing device 100 may be a personal digital assistant (PDA), a mobile telephone, a pager, a hand portable computing device, and the like. It is noted that mobile device 100 may be configured differently than the exemplary device shown in FIG. 1. Furthermore, some components which may typically be used in, for example, a cellular telephone, PDA, or other mobile electronic device, have been omitted from FIG. 1 for clarity. In the embodiment of FIG. 1, mobile device 100 comprises a computing system such as described in FIG. 4. For example, mobile device 100 will include a processor 402 coupled with an address/data bus 401. Processor 402 is for processing digital information and instructions and bus 401 is for conveying digital information between the various components of mobile device 100. Also coupled with bus 401 is a non-volatile read only memory (ROM) 404 for storing information and instructions of a more permanent nature, and a random access memory (RAM) 403 for storing the digital information and instructions of a more volatile nature.

Mobile device 100 includes a unique identifier, such as an IME or a specific Trimble number.

In one embodiment, handheld mobile device 100 includes a graphic user interface (GUI) 120. GUI 120 may be a liquid crystal device, cathode ray tube, a field emission display, or other display device suitable for creating graphic images and alpha-numeric characters recognizable to a user. For example, in one embodiment, GUI 120 may be a color display.

Mobile device 100 also includes a key/thumb board 110 and, in one embodiment, optional interactive buttons 115. In one embodiment, key/thumb board 110 is similar to alpha-numeric input 407 and may comprise a number of keys for inputting data, selections, updates, and for controlling mobile device 100.

In another embodiment, Mobile device 100 also includes one or more optional interactive buttons 115. Optional interactive buttons 115 may comprise a cursor control device (e.g., a mouse, trackball, light pen, touch pad, joystick, etc.) such as cursor control 408. In addition, optional interactive buttons 115 may comprise an optional image capture device such as a charge coupled device (CCD), a complementary metal oxide semiconductor (CMOS) digital image capture device or another digital image capture device. For example, the image capture device may be used to capture still images, or moving images.

With reference still to FIG. 1, mobile device 100 may also include a communications component such as input/output (I/O) device 409 described in FIG. 4. In one embodiment, the I/O device is a wireless communications component. As such, mobile device 100 may transmit and receive wireless messages and create local area networks. For example, the communications component may be a cellular antenna and modem, a wireless communications interface such as a Bluetooth or Wi-Fi transceiver, or the like. In another embodiment, mobile device 100 may comprise a serial or parallel wired communications component

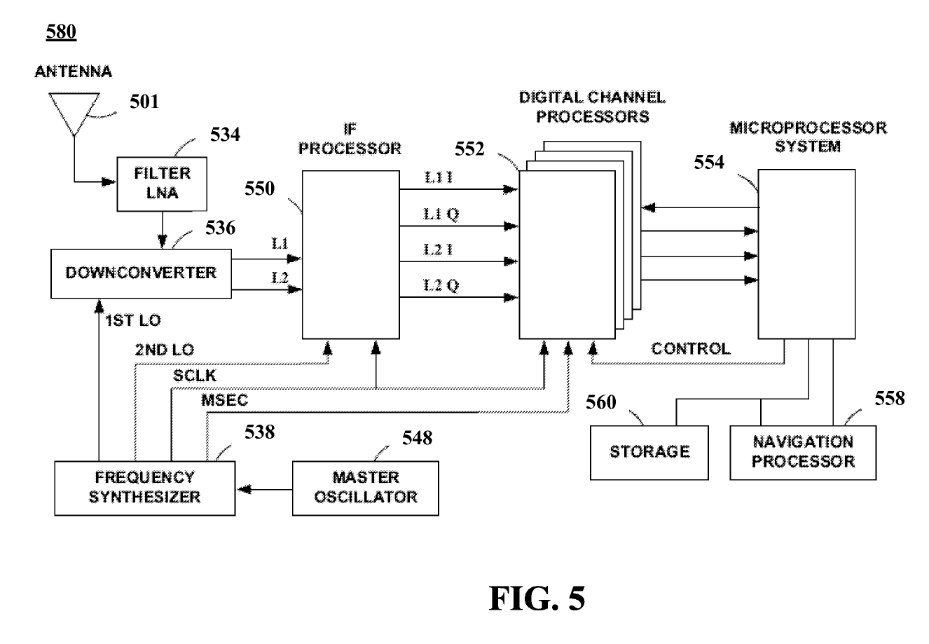

In one embodiment, mobile device 100 may include a position determining components such as a Global Navigation Satellite Service (GNSS) receiver and antenna as described in detail in FIG. 5. Although a GNSS receiver and antenna is described, mobile device 100 may be well suited to utilize a variety of terrestrial-based and satellite-based position determining systems. For example, terrestrial based broadcast signals such as LORAN-C, Decca, and radio beacons.

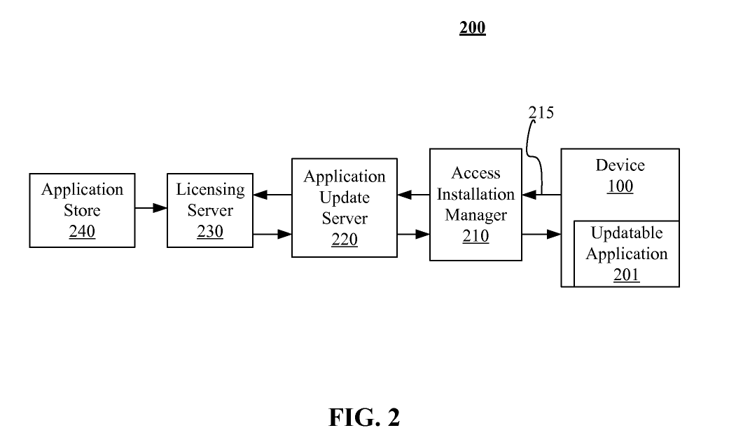

With reference now to FIG. 2, a block diagram 200 of one embodiment for updating or installing an updatable application 201 on a mobile device 100 is shown. In one embodiment, diagram 200 includes mobile device 100 having an updatable application 201 thereon. In addition, diagram 200 includes an access installation manager 210 communicatively coupled with mobile device 100 via connected arrows 215. In one embodiment, an application update server 220 is communicatively coupled with access installation manager 210. Additionally, licensing server 230 is communicatively coupled with application update server 220 and application store 240 is communicatively coupled with licensing server 230.

For purposes of the present discussion, mobile device 100 of FIG. 2 is typically the same device as mobile device 100 shown in FIG. 1.

In one embodiment, mobile device 100 is communicatively coupled with access installation manager 210 such that data is able to travel in two directions as shown by connected arrows 215. In one embodiment, the data connection is a wired connection such as a data cable. However, in another embodiment, the data is transferred between the access installation manager 210 and the mobile device 100 wirelessly.

In general, the access installation manager 210 has at least one updatable application 201 stored thereon. In one embodiment, the updatable application 201 is associated with a device identifier representing mobile device 100.

Access installation manager 210 is connected to an application update server 220. In one embodiment, the application update server 220 and the access installation manager 210 are connected via conventional bi-directional network connections. In general, the server 220 comprises a storage location for the updatable application 201 and updates for updatable applications 201 for installation on the device 100. Further details of the application update server 220 are described below.

In general, licensing server 230 is connected over a network to the application update server 220. In one embodiment, the licensing server 230 determines a selection of the updatable application 201 and updates for updatable applications 201 to be transmitted to the application update server 220. In one embodiment, licensing server 220 obtains the updatable application 201 and updates for updatable applications 201 from a store 240 such as, for example, the trimble.com iStore.

In an alternate embodiment, mobile device 100 comprises tablet hardware, and as such may have a color touch screen GUI and software keyboard. In one embodiment, when mobile device 100 is a tablet, the access installation manager 210 may run directly on the tablet mobile device and utilize a connection to the Internet to obtain updatable application 201 or updates to updatable application 201 for installation. In general, when the installation manger 210 determines that it is running on the mobile device 100 it uses its unique serial number to obtain updates in a similar way to that described above. In one embodiment, only updatable applications 201 that are designed, or at least designated, for the type of mobile device 100 will be available for the user to install.

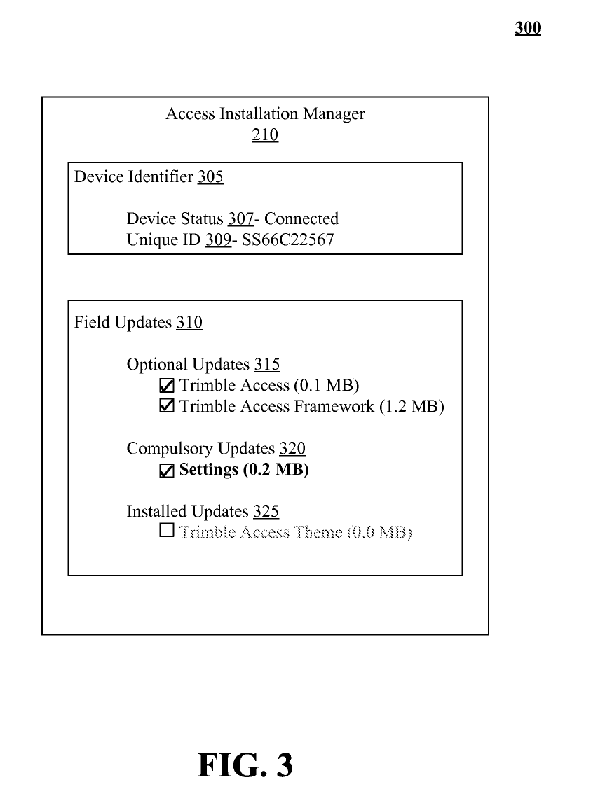

Referring now to FIG. 3, a block diagram of a user interface 300 presented to a user accessing the installation manager 210 is shown in accordance with one embodiment. In general, the access installation manager 210 may be connected with or operating directly on the mobile device 100.

In one example, access installation manager 210 includes a device identifier 305 portion and a field updates portion 310. In general, device identifier 305 provides device status 307 and unique ID 309. Specifically, device status 307 provides connection information to a user. For example, letting a user know if mobile device 100 is connected or not. Additionally, unique identifier 309, e.g., SS66C22567 allows a user to know which device access installation manager 210 is presently acting upon. Although unique ID 309 shows a device ID, the present technology is well suited to adding another field that provides a personalized and more easily recognizable identifier to the user. For example, “Ed's mobile”.

As previously stated, user interface 300 shows the installation manager having a set of field updates 310 stored therein. These field updates comprise several sets of computer executable instructions. These sets are all listed below the field updates heading. The list of field updates 310 is available to install on the mobile device 100. In one embodiment, the list of field updates 310 are broken down into sections, however, in another embodiment, the list of field updates 310 may be a single list that is not broken down into sections. Moreover, although three sub-fields are shown within the list of field updates 310, the technology is well suited for more, less or different sub-fields. For purposes of clarity, the following description of the list of field updates 310 includes optional updates 315, compulsory updates 320 and installed (or up-to-date) updates 325.

In general, optional updates 315 consist of updates that are available to install at the option of the user. In one embodiment, where updatable application 201 is available to install at the option of the user there is a populated check box presented beside the description of the updatable application 201. For some updatable applications 201 the check box will already be selected. This indicates to a user that the update is recommended. The user is able to deselect the update thereby issuing a direction not to install an item. Such items are installed by default. Other items are presented with an unpopulated check box. In these circumstances a user is able to populate the check box to issue a direction to install an item.

In contrast, compulsory updates 320 consist of items that must be installed on mobile device 100. Such items are indicated for example at 320. In one embodiment, compulsory updates 320 are presented in a different format than the items found under the optional updates 315 heading. For example, the items under compulsory updates 320 may be more prominently displayed, may be presented in a different color, or the like. In one embodiment, it is not possible for a user to populate or unpopulate the check box issuing a direction to install or a direction not to install items in the compulsory updates 320 section.

Installed updates 325 refers to items that are already installed or up to date on the mobile device 100. Descriptions of these items are presented in a manner that differentiates them when compared with other items. For example, up-to-date applications shown at 325 may not be as prominently displayed, may be grayed out, may be a different color than other updateable applications or the like. In another embodiment, for updatable applications 201 that are installed and up-to-date on the mobile device 100, field updates 310 interface may be configured to not allow a user to issue a direction to install or not install the update.

Thus, each device 100 associated with access installation manager 210, either the updatable application 201 or a pointer providing the locating of updatable application 201 (such as on a server) will be associated therewith. In addition, the access installation manager 210 may contain updatable application 201 updates that are ready to install on the mobile device 100. Moreover, the access installation manager 210 will associate all the different versions of updatable applications 201 found on the device 100 such that when there is an update ready for an updatable application 201 on device 100, the access installation manager 210 will have access to the update and will be able to automatically transmit it to device 100.

In one embodiment the application update server 220 continually searches for new updates ready to install. In one embodiment, once an update is made to the device 100, the event is recorded in the access installation manager 210 and the application update server 220. The application update server 220 maintains a set of device identifiers and the respective updatable applications 201 that are installed thereon.

The licensing server 230 provides a list of updatable application 201 updates, each associated with the device identifier, which are licensed to execute on the mobile device. In one embodiment, licensing server 230 generates the list of updatable application 201 updates from information obtained from the store 240. The resulting license file is used to determine which updatable application 201 is permitted to execute on the device 100. In other words, in one embodiment, the updatable application 201 utilized on the device 100 is controlled by the license file provided by the licensing server 230.

In one embodiment, the application updates server 220 contains a copy of the updatable application 201. In addition, in one embodiment, application updates server 220 determines which updates to make available to the device 100 based on the license from the licensing server 230. In another embodiment, application updates server 220 determines which updates to make available to device 100 based on information from store 240. Therefore, in one example operation, application updates server 220 will make one or more updatable application 201 updates available to the device 100 based at least partly on information obtained from the licensing server 230 and store 240.

In addition, the system provides for organizational level control for updates. For example, in an organization having a plurality of devices with the same updateable application 201 thereon, when an update is made available from the store 240, the licensing server 230 recognizes that the update is applicable to each device in the organization and then provides the update information along with each device identifier in the organization to the access installation manager 210. In so doing, the updates are able to ripple through the application update server 220, the access installation manager 210 and onto each device 100 within an organization.

The following is an example of mobile device update management in accordance with an embodiment. Although the example utilizes the installation of an updateable application 201, unless otherwise stated, the similar methodology may be used to update an updateable application 201 that is already installed on mobile device 100. In the example, an updatable application 201 for installation on device 100 is requested by the access installation manager 210. In one embodiment, the updatable application 201 is returned by the application updates server 220 to the access installation manager 210 in an electronic file. The electronic file contains information relevant to each installation such as, but not limited to, whether or not the update to updatable application 201 is compulsory, the version number, target hardware and/or target version.

One embodiment of a format for an installation file is XML. Set out below is an application segment sample XML file:

```
<install id=“123”>
    <file name=“Sample Applications/Sample.cab” action=“wceload”/>
    <name>Sample Updatable Application</name>
    <description>
      <en>An Update</en>
    </description>
    <version>1.2.3.4</version>
    <target_hardware>TSC2</target_hardware>
    <target_hardware>TCU</target_hardware>
    <target_version_location
type=“remote_registry”>HKEY_CURRENT_USER\Software\Trimble
Mobile\Applications\Sample Application\exe</target_version_location>
    <compulsory/>
  </install>
```

The sample file has an “install” element that may include an “id” attribute which represents an identifier for the installation action. In general, an install file can have multiple file entries.

The file element includes a name attribute and an action attribute. The “action” attributes tell the installation manager 210 how to install the update. For example, the update file may be installed using the WCE load.exe application on the device. Another attribute may include for example an “execute” attribute. Alternatively there is capacity to present no attribute for additional files required by one of the other installers. Other elements may include the name of the updatable application 201, description and version.

In one embodiment, a target hardware element indicates to the installation manager 210 what platforms the updatable application 201 can be installed on. This allows the installation manager 210 to filter out those mobile devices 100 which are not applicable. In the present example file the target hardware includes TSC2 and TCU.

The target version location element enables the access installation manager 210 to remain generic. For each application the relevant technique can be specified in the appropriate steps added to the installation manager 210. Typically, adding these steps involves writing a registry key that points to a file that can be used to determine the installed version. In the sample code above the target version location has the attribute type.

The sample file also indicates that the update installation is compulsory. As such, the version attribute of the above file is automatically updated when a new version is created by the build process.

As described above, the application updates server 220 automatically includes XML segments based on licensing information stored on the licensing server 230. Statements are written to a master XML file. An example statement is:

<include file=“Sample.xml” service=“Sample Application”/>

In the above example all users that are licensed to use “sample application” would receive this application installed on each of the individual user's mobile device 100.

In one embodiment, communication between the application update server 220 and the access installation manager 210 are made using HTTP REST. That is, using representational state transfer in which no state information is retained between requests. An example request may take the form:

https://servername/drp.php?organisation&serial=123456

The installation manager 210 receives several pieces of information, including which server it should communicate with.

Each controller's organization is assigned a server. This allows test organizations to communicate with development servers while end customers are assigned a production server and therefore a production or released file set. This enables development to co-exist on the servers along with the released products.

The following requests enable the installer to download the installed description file, the license file and the actual install files that the user selects for download and install.

https://servername/download.php?directory&serial_no=123456
https://servername/download.php?file=filename.ext&serial_no=123456&offset=0&size=9000
https://servername/download.php?checksum&file=filename.ext&serial_no=123456

### Example Computing System

Referring now to FIG. 4, a diagram of computer system 400 in accordance with one embodiment of the present invention is shown in greater detail. Within the discussions herein, it should be noted that certain processes and steps are discussed that are realized, in one embodiment, as a series of instructions (e.g., updatable application 201 program) that reside within computer readable memory units of system 400 and executed by processor 402 of system 400. When executed, the instructions cause the computer system 400 to perform specific functions and exhibit specific behavior as described.

In general, computer system 400 used by the embodiments of the present invention comprises an address/data bus 401 for communicating information, one or more central processors 402 coupled with the bus 401 for processing information and instructions, a computer readable volatile memory unit 403 (e.g., random access memory, static RAM, dynamic, RAM, etc.) coupled with the bus 401 for storing information and instructions for the central processor(s) 402, a computer readable non-volatile memory unit 404 (e.g., read only memory, programmable ROM, flash memory, EPROM, EEPROM, etc.) coupled with the bus 401 for storing static information and instructions for the processor(s) 402.

System 400 also includes a mass storage computer readable data storage device 405 such as a magnetic or optical disk and disk drive coupled with the bus 401 for storing information and instructions. Optionally, system 400 can include a display device 406 coupled to the bus 401 for displaying information to the computer user (e.g., maintenance technician, etc.), an alphanumeric input device 407 including alphanumeric and function keys coupled to the bus 401 for communicating information and command selections to the central processor(s) 402, a cursor control device 408 coupled to the bus for communicating user input information and command selections to the central processor(s) 402, and a signal generating input/output device 409 coupled to the bus 401 for communicating command selections to the processor(s) 402.

### Example GNSS Receiver

With reference now to FIG. 5, a block diagram is shown of an embodiment of an example GNSS receiver which may be used in accordance with various embodiments described herein. In particular, FIG. 5 illustrates a block diagram of a GNSS receiver in the form of a general purpose GPS receiver 580 capable of demodulation of the L1 and/or L2 signal(s) received from one or more GPS satellites. For the purposes of the following discussion, the demodulation of L1 and/or L2 signals is discussed. It is noted that demodulation of the L2 signal(s) is typically performed by “high precision” GNSS receivers such as those used in the military and some civilian applications. Typically, the “consumer” grade GNSS receivers do not access the L2 signal(s).

Embodiments of the present technology may be utilized by GNSS receivers which access the L1 signals alone, or in combination with the L2 signal(s). A more detailed discussion of the function of a receiver such as GPS receiver 580 can be found in U.S. Pat. No. 5,621,426. U.S. Pat. No. 5,621,426, by Gary R. Lennen, entitled “Optimized processing of signals for enhanced cross-correlation in a satellite positioning system receiver,” incorporated by reference which includes a GPS receiver very similar to GPS receiver 580 of FIG. 5.

In FIG. 5, received L1 and L2 signal is generated by at least one GPS satellite. Each GPS satellite generates different signal L1 and L2 signals and they are processed by different digital channel processors 552 which operate in the same way as one another. FIG. 5 shows GPS signals (L1=1575.42 MHz, L2=1227.60 MHz) entering GPS receiver 580 through a dual frequency antenna 501. Antenna 501 may be a magnetically mountable model commercially available from Trimble® Navigation of Sunnyvale, Calif., 94085. Master oscillator 548 provides the reference oscillator which drives all other clocks in the system. Frequency synthesizer 538 takes the output of master oscillator 548 and generates important clock and local oscillator frequencies used throughout the system. For example, in one embodiment frequency synthesizer 538 generates several timing signals such as a 1st LO1 (local oscillator) signal 1400 MHz, a 2nd LO2 signal 175 MHz, a (sampling clock) SCLK signal 25 MHz, and a MSEC (millisecond) signal used by the system as a measurement of local reference time.

A filter/LNA (Low Noise Amplifier) 534 performs filtering and low noise amplification of both L1 and L2 signals. The noise figure of GPS receiver 580 is dictated by the performance of the filter/LNA combination. The downconverter 536 mixes both L1 and L2 signals in frequency down to approximately 175 MHz and outputs the analogue L1 and L2 signals into an IF (intermediate frequency) processor 30. IF processor 550 takes the analog L1 and L2 signals at approximately 175 MHz and converts them into digitally sampled L1 and L2 inphase (L1 I and L2 I) and quadrature signals (L1Q and L2 Q) at carrier frequencies 420 KHz for L1 and at 2.6 MHz for L2 signals respectively.

At least one digital channel processor 552 inputs the digitally sampled L1 and L2 inphase and quadrature signals. All digital channel processors 552 are typically identical by design and typically operate on identical input samples. Each digital channel processor 552 is designed to digitally track the L1 and L2 signals produced by one satellite by tracking code and carrier signals and to form code and carrier phase measurements in conjunction with the microprocessor system 554. One digital channel processor 552 is capable of tracking one satellite in both L1 and L2 channels.

Microprocessor system 554 is a general purpose computing device which facilitates tracking and measurements processes, providing pseudorange and carrier phase measurements for a navigation processor 558. In one embodiment, microprocessor system 554 provides signals to control the operation of one or more digital channel processors 552. Navigation processor 558 performs the higher level function of combining measurements in such a way as to produce position, velocity and time information for the differential and surveying functions. Storage 560 is coupled with navigation processor 558 and microprocessor system 554. It is appreciated that storage 560 may comprise a volatile or non-volatile storage such as a RAM or ROM, or some other computer readable memory device or media.

One example of a GPS chipset upon which embodiments of the present technology may be implemented is the Maxwell™ chipset which is commercially available from Trimble® Navigation of Sunnyvale, Calif., 94085.

Embodiments of the present invention are thus described. While the present invention has been described in numerous embodiments, the foregoing descriptions of embodiments of the present invention have been presented for purposes of illustration and description. They are not intended to be exhaustive or to limit the invention to the precise forms disclosed, and many modifications and variations are possible in light of the above teaching. The embodiments were chosen and described in order best to explain the principles of the invention and its practical application.

1. A method of updating an application on a mobile device, the method comprising:
obtaining a device identifier from the mobile device;
obtaining from an installation manager at least one updatable application, associated with the device identifier, that is available to install on the mobile device;
installing the at least one updatable application on the mobile device; and
updating the installation manager to represent that the at least one updatable application is installed on the mobile device.

2. The method of claim 1 further comprising maintaining, on an application updates server, the at least one updatable application, associated with the device identifier, that is installed on the mobile device.

3. The method of claim 2 further comprising:
obtaining, from a licensing server, the at least one updatable application, associated with the device identifier, that is licensed to execute on the mobile device; and
storing the at least one updatable application obtained from the licensing server on the application updates server.

4. The method of claim 3 further comprising presenting on a display device, a list of application names, the application names representing at least a second updatable application that is available to install on the mobile device.

5. The method of claim 4 wherein at least one of the list of application names represents said at least a second updatable application available to optionally install.

6. The method of claim 5 further comprising:
receiving a direction to install said at least a second updatable application.

7. The method of claim 5 further comprising:
receiving a direction to not install said at least a second updatable application.

8. The method of claim 5 further comprising:
presenting said at least a second updatable application with a recommendation to be installed by default on said mobile device.

9. The method of claim 8 further comprising:
permitting a selection to not install said at least a second updatable application with a recommendation to be installed by default on said mobile device.

10. The method of claim 4 wherein at least one of the list of items represents said at least a second updatable application that must be installed on the mobile device.

11. The method of claim 4 wherein at least one of the list of items represents said at least a second updatable application already installed on the mobile device.
